(19) United States
(12) Patent Application Publication
(10) Pub. No.: US 2025/0368208 A1
(43) Pub. Date: Dec. 4, 2025

(54) MOTION PREDICTION FOR MOBILE AGENTS

(71) Applicant: Five AI Limited, Cambridge (GB)

(72) Inventor: Anthony Knittel, Cambridge (GB)

(73) Assignee: Five AI Limited, Cambridge (GB)

(21) Appl. No.: 18/874,182

(22) PCT Filed: Jun. 13, 2023
(86) PCT No.: PCT/EP2023/065859

§ 371 Date: Dec. 12, 2024

(30) Foreign Application Priority Data
Jun. 14, 2022 (GB) 2208732.4

(51) Int. Cl. B60W 50/00; B60W 60/00; G06N 3/0464

(52) U.S. Cl. CPC B60W 50/0097; B60W 60/0011; G06N 3/0464

(57) ABSTRACT

A method of predicting trajectories for agents of a scenario, the method comprising, for each agent generating an agent feature vector based on one or more observed past states of the agent, computing a set of pairwise feature vectors, each computed as a combination of the agent feature vector for that agent with a respective agent feature vector generated for each other agent of the scenario, processing the pairwise feature vectors as independent inputs to one or more interaction layers of a trajectory prediction neural network to generate a pairwise output for each pairwise feature vector, aggregating the pairwise outputs over the other agents of the scenario to generate an interaction-based feature representation for each agent, processing the interaction-based feature representation in one or more prediction layers of the trajectory prediction neural network, and generating, based on the output of the one or more prediction layers, at least one predicted trajectory for each agent.

### TECHNICAL FIELD

The present disclosure pertains generally to motion prediction. The motion prediction techniques have applications in autonomous driving and robotics more generally, for example to support motion planning in autonomous vehicles and other mobile robots.

### BACKGROUND

A rapidly emerging technology is autonomous vehicles (AVs) that can navigate by themselves on urban roads. Such vehicles must not only perform complex maneuvers among people and other vehicles, but they must often do so while guaranteeing stringent constraints on the probability of adverse events occurring, such as collision with these other agents in the environments. An autonomous vehicle, also known as a self-driving vehicle, refers to a vehicle which has a sensor system for monitoring its external environment and a control system that is capable of making and implementing driving decisions automatically using those sensors. This includes in particular the ability to automatically adapt the vehicle's speed and direction of travel based on perception inputs from the sensor system. A fully-autonomous or “driverless” vehicle has sufficient decision-making capability to operate without any input from a human driver. However, the term autonomous vehicle as used herein also applies to semi-autonomous vehicles, which have more limited autonomous decision-making capability and therefore still require a degree of oversight from a human driver. Other mobile robots are being developed, for example for carrying freight supplies in internal and external industrial zones. Such mobile robots would have no people on board and belong to a class of mobile robot termed UAV (unmanned autonomous vehicle). Autonomous air mobile robots (drones) are also being developed.

Prediction of the future motion of surrounding vehicles is essential for operating an Autonomous Vehicle. In order to support a motion planner for the ego vehicle, a predictor needs to estimate the future states of the surrounding vehicles and other agents, based on observation of their recent history.

In order to plan safe actions in a given scenario, an autonomous vehicle or other mobile robot needs to predict the future state of the scenario to anticipate and avoid adverse outcomes such as collisions. When planning a trajectory for an autonomous vehicle in the presence of other agents, such as vehicles, pedestrians, cyclists, etc., it is therefore important to generate realistic predictions of the future states of those agents to enable the autonomous vehicle (ego agent) to avoid any collision or otherwise dangerous interaction with the other agents of the scenario. One possible option is to apply a per-agent approach to prediction, wherein a prediction is made for each agent independently based on the observed states of that agent, for example using a learned agent model or by applying rules or heuristics based on assumptions about expected agent behaviour.

### SUMMARY

Existing per-agent prediction methods can learn to predict the behaviour of individual agents interacting with a known environment based on learned agent models or rules and heuristics. However, these techniques do not take into account the possible future interactions between agents based on their state at a given point of a scenario, where in real-life scenarios, agents adapt their behaviour based on how other agents might behave in future.

Some road scenarios result in significant interaction between agents in the scene, and it is important to be able to predict future vehicle states in these scenarios that captures specific motions that other agents may take. The planned behaviour of agents is influenced by observing other actors nearby, and in addition the resulting motion that agents follow can include reactions to unexpected motions by other agents.

One possible way to handle scenarios of multiple agents is to provide a single input representing all agents of a scene to a prediction model, such as a neural network trained to predict a set of agent trajectories based on the past states of all agents.

However, generating a single input for the scene requires combining state information (e.g. a vector of past states) for each agent in some order to form a single vector or matrix input to the prediction model. According to this method, the agents may be ordered, for example, based on their relative positions in the scene. This leads to possible issues in prediction as the prediction network learns different weights associated to each input element and may therefore learn patterns in agent behaviour based on their relative position within the scene, or based on any other criteria used to order the agents, thereby assigning each agent a certain ‘role’ within a scene that is learned by the network and used to predict future behaviour. A further problem with this approach is that the input to the prediction modelled would be fixed to a certain size which corresponds to a scenario with a fixed number of agents. This is inflexible as in practice a wide variety of scenarios may be encountered with different numbers of agents.

Described herein is an interactive prediction method that uses a general learning approach to determine predicted trajectories for agents that take interactions into account without requiring any underlying assumptions about the role of the different agents of the scene and without requiring any additional rules or heuristics to inform the prediction.

According to the method described herein, the agents of the scenario are treated as an unordered set, and each is processed as an independent input to the network, generating an interaction-based representation of each agent by processing a combined representation of that agent with each other agent of the scene. This allows the network to learn to predict trajectories based on the information known about the agents, such as their past behaviour and their dimensions, as well as information about the other agents of the scenario, with a focus on pairwise interactions. The prediction network in this case is not limited to a fixed number of agents and does not predict trajectories based on learned trends in behaviours due to criteria used to form an ordered set of agents forming an overall scene input, therefore having greater flexibility and generalisability to different types of scenarios.

The method described below takes pairwise interactions of agents into account. This is implemented by a neural network architecture that takes as input state information about each agent to generate a representation for each agent, and broadcasts the state information over all other agents to generate pairwise representations for each pair of agents, which are processed by the network to generate predicted trajectories for each agent that are interaction-aware.

A first aspect herein is directed to a computer-implemented method of predicting trajectories for agents of a scenario, the method comprising, for each agent: generating an agent feature vector based on one or more observed past states of the agent, computing a set of pairwise feature vectors, each pairwise feature vector computed as a combination of the agent feature vector for that agent with a respective one of the agent feature vectors generated for each other agent of the scenario, processing the pairwise feature vectors as independent inputs to one or more interaction layers of a trajectory prediction neural network to generate a pairwise output for each pairwise feature vector, aggregating the pairwise outputs over the other agents of the scenario to generate an interaction-based feature representation for each agent, and processing the interaction-based feature representation in one or more prediction layers of the trajectory prediction neural network, and generating, based on the output of the one or more prediction layers, at least one predicted trajectory for each agent.

The agent feature vector may be further based on one or more spatial dimensions of the agent. The agent feature vector may be determined based on a temporal convolution of a time series of past states of the each agent. Each state may comprise one or more of a position, orientation and velocity of the agent at a given timestep.

The past states of each agent may be obtained by applying a perception system to one or more sensor outputs. Alternatively, the past states may be obtained by manual annotation of sensor data. The sensor outputs may comprise radar data, lidar data and/or camera images.

Each pairwise feature vector may be computed by concatenating the agent feature vector of each agent with a different respective one of the agent feature vectors of the other agents of the scenario.

The interaction-based feature representation may be combined with the agent feature vector before being input to the prediction layers. This combination may comprise a concatenation operation of the agent feature vector of each agent with the interaction-based feature representation for each agent, where the interaction-based feature representation comprises an interaction feature vector for each agent.

The output of a first set of prediction layers for each agent may be combined with a common scene context representation, wherein the combination for each agent is processed by a second set of prediction layers to generate a predicted trajectory for each agent. The scene context representation may be computed by aggregating the outputs of the first set of prediction layers over the agents of the scene.

The pairwise outputs may be aggregated by performing a max reduction operation, which computes, for a given reference agent of the pairwise outputs the maximum feature value over all comparison agents of that reference agent for each feature.

The context representation may be computed by performing a max reduction operation over the agents of the scene, by computing, for the scene as a whole, the maximum feature value of each feature over all intermediate outputs.

The trajectory prediction neural network may be configured to generate a fixed number of predicted trajectories, each predicted trajectory corresponding to a different prediction mode. The number of prediction modes may be predetermined.

The trajectory prediction neural network may be further configured to output a weight for each prediction mode, wherein the weight indicates a confidence in each prediction mode. The trajectory prediction neural network may be further configured to generate a spatial distribution over predicted trajectories, the distribution encoding uncertainty in the predicted trajectory of each agent.

The trajectory prediction neural network may be trained by predicting trajectories for scenarios of a training set for which observed trajectories are known, and optimising a loss function that penalises deviations between predicted trajectories and observed trajectories of the training set. It should be noted that a ‘loss’ function is used generally herein to refer to any function which is optimised in training a neural network. Minimising a loss function such as error can be considered equivalent to maximising a reward function defining the similarity between a predicted trajectory and a ground truth trajectory.

One of the agents of the scenario may be an autonomous vehicle agent. The predicted trajectories generated by the trajectory prediction neural network may be output to an autonomous vehicle planner to generate a plan for the autonomous ego vehicle agent in the presence of other agents of the scenario. The predicted trajectories generated by the network for the agents of the scenario may be used by the planner to determine one or more safe actions for the ego vehicle. The planner may be configured to choose ego actions to as to avoid collisions with other agents of the scenario.

The method may comprise generating, by a controller, control signals to implement the planned trajectory for the autonomous ego vehicle agent.

A second aspect herein provides a method of training a trajectory prediction neural network, the method comprising: receiving a plurality of training instances, each training instance comprising a set of past states for a plurality of agents of a scenario and a corresponding ground truth trajectory for each agent; for each agent of a training instance: generating an agent feature vector for each agent based on one or more observed past states of the agent, computing a set of pairwise feature vectors, each pairwise feature vector computed as a combination of the agent feature vector for that agent with a respective one of the agent feature vectors generated for each other agent of the scenario, processing the pairwise feature vectors as independent inputs to one or more interaction layers of a trajectory prediction neural network to generate a pairwise output for each pairwise feature vector, aggregating the pairwise outputs over the other agents of the scenario to generate an interaction-based feature representation for each agent, processing the interaction-based feature representation in one or more prediction layers of the trajectory prediction neural network, and generating, based on the output of the one or more prediction layers, at least one predicted trajectory for each agent; updating one or more parameters of the trajectory prediction neural network so as to optimise a loss function based on the at least one predicted trajectory for each agent and the corresponding ground truth trajectory for that agent.

The loss function may comprise one or more of a spatial distribution loss function, a regression loss function, and a mode weight estimation loss function.

Further aspects are directed to a computer program comprising computer readable-instructions for programming a computer system to implement the method of the first aspect or any embodiment thereof, and a computer system comprising one or more computers configured to implement the same.

### BRIEF DESCRIPTION OF FIGURES

For a better understanding of the present disclosure, and to show how embodiments of the same may be carried into effect, reference is made by way of example only to the following figures in which:

FIG. 1 shows a schematic block diagram of an autonomous vehicle stack;

FIG. 2 shows a schematic block diagram of a neural network architecture for interactive prediction.

### DETAILED DESCRIPTION

Described herein are methods for generating predicted trajectories for agents of a scene, taking interactions between agents into account. Accurate prediction is important for operating an Autonomous Vehicle in interactive scenarios. A neural network architecture, referred to herein as DiPA (Diverse and Probabilistically Accurate Interactive Prediction), is presented herein. This network produces diverse predictions while also capturing accurate probability estimates. DiPA produces predictions as a Gaussian Mixture Model representing a spatial distribution, with a flexible representation that is generalisable to a wider range of scenarios than previous methods. This shows state-of-the-art performance on the Interaction dataset using closest-mode evaluations, and on the NGISM dataset using probabilistic evaluations.

Previous methods of evaluating predictions have focused on evaluations that measure the closest predicted mode against the ground-truth, which evaluate how closely the prediction set covers observed instances, however do not evaluate when additional modes are being predicted that are not likely to occur.

These can interfere with operation of an AV as they can imply high probability of conflict in regions that have low probability, impairing effective planning. Probabilistic measures, such as predicted-mode-RMS and negative-log-likelihood evaluation, described herein, are used for evaluation of multi-modal predictions in interactive scenarios, in addition to the existing closest-mode measures. Previous NLL calculations have issues with unbounded values that can distort evaluations. A revision of NLL evaluation is described below, which aims to address this problem.

Multi-modal predictions are particularly important in interactive scenarios, as there can be multiple distinct outcomes that are likely to occur. As an example, in a lane-merging scenario with two vehicles approaching at similar distances and speeds, one of the vehicles will likely pass first and the other will slow down. However either vehicle may become the first vehicle, resulting in two distinct modes of behaviour.

It is important for an interactive predictor to capture these distinct modes, and existing methods using the Interaction dataset have focused on this problem, to measure how closely specific observed behaviours are captured by one of a set of predicted trajectory modes. This is evaluated using closest-mode evaluations such as minimum average or final displacement error (minADE/minFDE) and miss-rate (MR) evaluations, which compares the closest prediction with the ground truth. Additional predicted modes do not affect scoring, so there is no assessment of whether the model is also predicting instances that are unlikely to occur. The probability of modes, or the spatial distribution of each predicted trajectory, are not evaluated.

Probability estimates of each mode are important to consider, particularly for a planner controlling an AV. The planner needs to consider the risk of conflict from different ego actions and to identify regions the ego vehicle can proceed to with low probability of conflict.

For example if the ego vehicle is proceeding along a lane with right of way over a second approaching lane, an approaching vehicle is most likely to give way and allow ego to proceed, however there is a chance that they will continue and not stop. A multi-modal prediction can show that two behaviours for the second vehicle may be expected, representing the two possible outcomes: that the second vehicle gives way, and that the second vehicle cuts in. The ego vehicle will need to assess the risk that the second vehicle will cut in front of it, requiring a probabilistic estimate of the modes of behaviour. If equal probability is given to each mode the ego vehicle may need to perform a rapid stop to avoid the perceived risk of collision, while if the probability is considered low it can produce a balanced estimate of the best way to proceed.

In addition, it is possible to produce a perfect score using closest-most scoring while also producing predictions that have no connection with observed data at all, such as unrealistic kinematic motions or other behaviours with no real basis. The presence of these predictions will interfere with effective AV planning, and probabilistic scoring can identify and penalise such unrealistic predictions.

Existing evaluations using closest-mode scoring do not show how well predictors are able to model the probability of outcomes in interactive scenarios, and how well they balance the competing task of capturing instances closely with producing accurate estimates of the different behaviour modes.

Probabilistic evaluations have been used on highway driving datasets such as NGSIM, using predicted-mode root-mean-square (predRMS) and negative-log-likelihood (NLL) scoring. These evaluation measures compare how well mode probability estimates and the predicted spatial distribution represents observed instances in the dataset. A disadvantage of these evaluation measures is that a good probabilistic score can be produced when using a conservative prediction similar to the mean of possible futures without closely representing individual instances.

Different evaluation measures are supported by different prediction strategies. Closest-mode evaluation (e.g. minADE/FDE/MR) emphasises diversity of predictions, while probabilistic evaluations (predRMS, NLL) encourage conservative predictions, where the average error is minimised. When a diverse strategy is used the resulting error from incorrectly predicted modes is higher than with conservative predictions.

In order to produce useful predictions for supporting an AV planner on interactive scenarios, it is important to predict diverse predictions along with accurate probabilistic estimates, and to evaluate the two aspects together.

DiPA is presented herein as a method for addressing both closest-mode and probabilistic prediction on interactive scenarios.

Both closest-mode and probabilistic evaluations are used herein to evaluate predictions, to account for the trade-off between diverse and accurate prediction strategies.

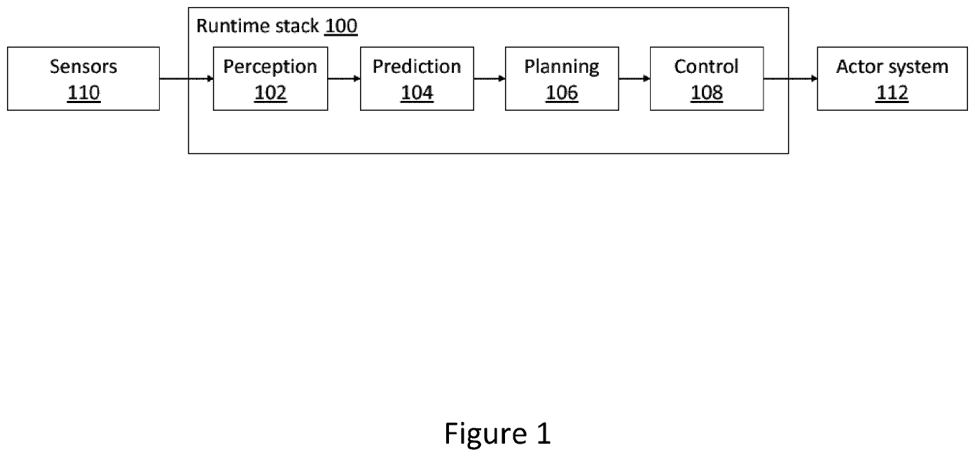

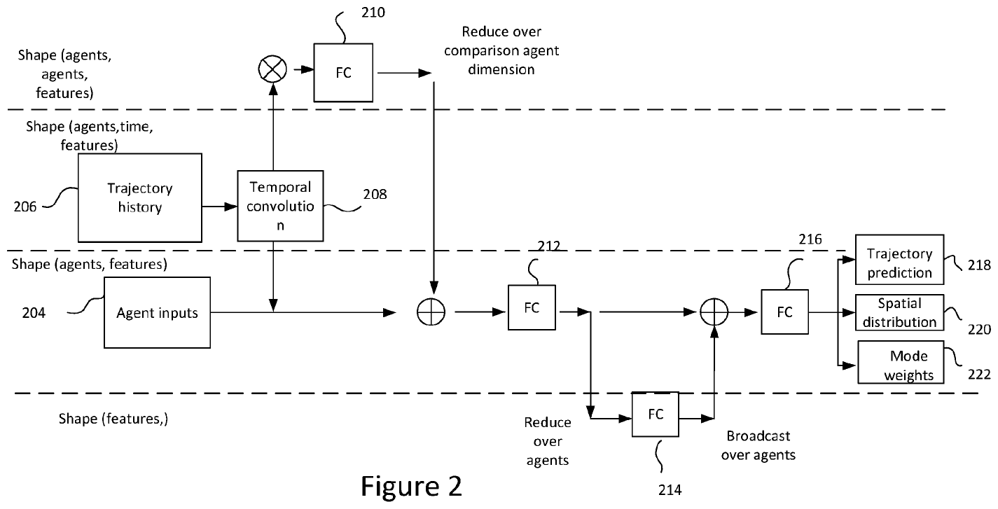

To provide relevant context to the described embodiments, a discussion of existing methods of performing interactive prediction is provided below. Further details of an example form of AV stack are provided and the method of the present invention will then be described with reference to FIGS. 1 and 2.

### Interactive Prediction

Interactive prediction has been explored by a number of different approaches. Goal based methods such as TNT [4] uses a goal-directed model that identifies a number of potential future targets that each agent may be heading towards, determines likelihoods that each goal may be followed and produces predicted trajectories towards those goals. DenseTNT [5] extends this approach based on a larger and more varied set of target positions in the lane regions that the agent is approaching. Flash [6] uses a combination of analytical methods and neural networks to produce accurate predictions of trajectories in highway driving scenarios. This goal-based approach identifies candidate road positions that vehicles may be headed towards estimates the likelihood that each goal is being followed using Bayesian inverse planning, and produces trajectories based on a combination of a goal-based trajectory generation function and motion profile generation using an ensemble of Mixture-Density Networks. This approach allows interpretability of the predicted trajectories, and generates a number of predicted modes using goals as a specific factor for each mode which allows high accuracy of mode prediction and accurate trajectory prediction with highway driving. Goal-based representations have advantages from use of the map information to inform generation of trajectories, and can use kinematically sound trajectory generation methods, however these can produce limited diversity on properties other than goals compared to data-driven methods.

Graph based methods such as ReCoG [7] combines map information and agent positions into a common representation, and uses graph neural networks to model interactions between elements of the scene, and generates trajectories based on a RNN decoder. Jia et al. [8] extend a graph-based model to allows the scene to be considered from each agent's point of view rather than by selecting a single central agent, using a combination of ego-centric and collective representations, and performing inference based on a recursion of each agents' model of other agent behaviours.

GoHome [9] uses a graph to encode context of the scene such as agent positions and lanes, and produces a prediction as a raster-based heatmap representing the probability distribution of future positions. Predicted trajectories are sampled from the heatmap for comparison against instances of the dataset. StarNet [10] represents the topological structure of the scene and agents using vector-based graphs, and performs single agent and joint prediction of predicted joint future of the agents in the scene. This combines the interpretation of agents within their own reference frame with the perspective of the agent from the points of view of other agents. Joint future prediction model shows advantages over the single agent approach.

Sample-based models use a different approach for producing future instances, by using a localised model of a specific agent and timestep and generating predicted instances for each agent in the scene that are rolled forwards to simulate future states along with interactions. ITRA [11] uses a generative model to predict short-term future positions, based on local information encoded in an image representation, which is applied on each agent and timestep to generate interactive futures. Regression-based methods use a simplified representation to map observations directly to predicted outputs. SAMMP [12] produces joint predictions of the spatial distribution of vehicles based on a recurrent neural network model, using a multi-head self-attention function to capture interactions between agents. Multiple-Futures Prediction (MFP) [13] describes a method for modelling the joint futures of a number of interacting agents in the scene, based in a number of learnt latent variables that are used for generating a number of predicted future modes. Surrounding neighbours are represented in a discrete grid corresponding to their offset positions in neighbouring lanes. Mersch et al. [14] present a temporal-convolution based method for prediction of interacting vehicles in a highway scenario. Neighbouring agents are assigned specific roles based on relative positions from a central agent, such as front, front-left, rear-right and so on, which are fed into a temporal-convolution structure. The model is trained using classification of predicted maneuvers such as lane changes or lane-follow behaviours, which are used to influence trajectory predictions. These methods can be fast and accurate, although many use a specific assignment of roles based on relative positions of neighbours, which can limit generalisability to scenarios with different layouts.

PiP [15] describes a method for prediction on highway driving scenarios that considers the role of the ego vehicle operating in the scene when producing predictions. A number of candidate plans for controlling the ego vehicle are considered, and predictions of other agents are produced conditionally from the proposed plans, providing a prediction method with benefits for supporting the planner of an autonomous vehicle.

Existing models have demonstrated good results on closest-mode evaluations, such as minADE/FDE/MR evaluations on the INTERACTION dataset, or on probabilistic evaluations, such as predRMS and NLL on NGSIM, but have not shown the ability to address the joint task of producing diverse predictions at the same time as maintaining good prediction accuracy, in a generalisable way that can be applied to the diverse scenes that occur in interactive scenarios.

The method herein produced multi-model predictions with a spatial distribution represented as a Gaussian Mixture model. Neighbouring agents are treated as symmetric entities in an unordered set, addressing issues with previous methods that assign specific roles to neighbouring agents which does not generalise well to different road layouts.

FIG. 1 shows a highly schematic block diagram of an AV runtime stack 100. The run time stack 100 is shown to comprise a perception (sub-)system 102, a prediction (sub-)system 104, a planning (sub-)system (planner) 106 and a control (sub-)system (controller) 108. As noted, the term (sub-)stack may also be used to describe the aforementioned components 102-108.

In a real-world context, the perception system 102 receives sensor outputs from an on-board sensor system 110 of the AV, and uses those sensor outputs to detect external agents and measure their physical state, such as their position, velocity, acceleration etc. The on-board sensor system 110 can take different forms but generally comprises a variety of sensors such as image capture devices (cameras/optical sensors), lidar and/or radar unit(s), satellite-positioning sensor(s) (GPS etc.), motion/inertial sensor(s) (accelerometers, gyroscopes etc.) etc. The onboard sensor system 110 thus provides rich sensor data from which it is possible to extract detailed information about the surrounding environment, and the state of the AV and any external actors (vehicles, pedestrians, cyclists etc.) within that environment. The sensor outputs typically comprise sensor data of multiple sensor modalities such as stereo images from one or more stereo optical sensors, lidar, radar etc. Sensor data of multiple sensor modalities may be combined using filters, fusion components etc.

The perception system 102 typically comprises multiple perception components which co-operate to interpret the sensor outputs and thereby provide perception outputs to the prediction system 104.

The perception outputs from the perception system 102 are used by the prediction system 104 to predict future behaviour of external actors (agents), such as other vehicles in the vicinity of the AV.

Predictions computed by the prediction system 104 are provided to the planner 106, which uses the predictions to make autonomous driving decisions to be executed by the AV in a given driving scenario. The inputs received by the planner 106 would typically indicate a drivable area and would also capture predicted movements of any external agents (obstacles, from the AV's perspective) within the drivable area. The driveable area can be determined using perception outputs from the perception system 102 in combination with map information, such as an HD (high definition) map.

A core function of the planner 106 is the planning of trajectories for the AV (ego trajectories), taking into account predicted agent motion. This may be referred to as trajectory planning. A trajectory is planned in order to carry out a desired goal within a scenario. The goal could for example be to enter a roundabout and leave it at a desired exit; to overtake a vehicle in front; or to stay in a current lane at a target speed (lane following). The goal may, for example, be determined by an autonomous route planner (not shown).

The controller 108 executes the decisions taken by the planner 106 by providing suitable control signals to an on-board actor system 112 of the AV. In particular, the planner 106 plans trajectories for the AV and the controller 108 generates control signals to implement the planned trajectories. Typically, the planner 106 will plan into the future, such that a planned trajectory may only be partially implemented at the control level before a new trajectory is planned by the planner 106. The actor system 112 includes “primary” vehicle systems, such as braking, acceleration and steering systems, as well as secondary systems (e.g. signalling, wipers, headlights etc.).

Note, there may be a distinction between a planned trajectory at a given time instant, and the actual trajectory followed by the ego agent. Planning systems typically operate over a sequence of planning steps, updating the planned trajectory at each planning step to account for any changes in the scenario since the previous planning step (or, more precisely, any changes that deviate from the predicted changes). The planning system 106 may reason into the future, such that the planned trajectory at each planning step extends beyond the next planning step.

FIG. 2 is a schematic block diagram of an example neural network architecture that may be used to perform interaction-based agent trajectory prediction, for example to predict agent trajectories for agents of a driving scenario based on which an autonomous vehicle stack can plan a safe trajectory. The network receives a set of trajectory histories 206 comprising a set of past states for each agent of a scenario. Each trajectory history may be in the form of a time series of agent states over some past time interval, each state including the position, orientation and velocity of the agent at a corresponding point in time. At least one past agent state is received for each agent. Other agent inputs 204 may also be received, such as a set of spatial dimensions for each agent. These agent inputs and agent histories may be derived from sensor data by a perception subsystem 102 of an AV stack 100. The trajectory histories are processed by one or more temporal convolution layers 108 to generate a feature vector for each agent that is time-independent.

As shown in FIG. 2, the set of trajectory histories 206 is an array having shape (agents, time, features), i.e. for each agent, a set of features is input defining the state of the agent at each timestep of the time interval. Note that ‘features’ is used herein to refer to a representative set of values, and different feature representations are used in different parts of the network. In other words, ‘features’ when used to describe a dimension of an input or output of the network can refer to different numbers and types of features for different inputs and outputs. For the trajectory history, for example, the feature values represent the position, orientation and velocity of the agent at the selected point in time, and the features output from the temporal convolution represent the states of the agent over the entire time interval. Note that the dimensionality shown in FIG. 2 excludes the feature dimension.

The convolved trajectory histories are broadcast over all agents as shown by the ⊗ symbol, for example by concatenating the feature vector for each agent with each feature vector associated with each other agent of the scenario. Each combination of two agents is associated with a respective pairwise feature, which is processed by one or more interaction layers 210 of the neural network. These may be fully connected (FC) layers as shown. The output of the interaction layers 210 is a respective feature vector for each pairwise combination of agents, which is subsequently reduced (aggregated) over one agent dimension. Note that each agent is treated as an independent input to the network, similarly to elements of a batch, rather than as components of a single input that the network learns to process according to an assigned role.

For clarity, herein a first agent of each pair is referred to as the ‘reference’ agent while the second agent of the pair is referred to as the ‘comparison’ agent. All agents of the scenario act as both a reference agent and a comparison agent. The reduction is over the comparison agent dimension, such that a respective interaction representation is output for each agent of the scenario. Example reduction operations include max reductions, where for a given reference agent the maximum value for each feature is selected over all comparison agents, and a sum, which gives the sum of each feature over all the comparison agents. The reduced interaction representation feature vectors, which have dimension (agents, features) is combined with the additional agent inputs, as well as the convolved histories, which also have dimension (agents, features), although, as noted above, the number of features for the interaction representation and the agent inputs need not be the same. These are combined in the present example by concatenating the agent input (combined with the convolved agent histories) and the interaction representation vector for each agent as shown by the ⊕ in Figure B. This combined feature representation for each agent is processed by a set of prediction layers 212 and 216. A scene context may also be generated by reducing an intermediate output of a first set of prediction layers 212 and processing this in a set of context layers 214, with the output being broadcast to the intermediate output for each agent, for example by concatenating the scene context with each intermediate output as generated for each agent, before processing the combined agent representations in a second set of prediction layers 216 to generate a final predicted output including a trajectory prediction 218. In the present example, the neural network is configured to make predictions for each of a fixed number of prediction ‘modes’, where the number of modes, for example five, is predetermined. The output generates a predicted trajectory 218 for each mode, as well as a spatial distribution indicating uncertainty of the trajectory itself in space, as well as a weight which indicates a predicted mode, where the mode with the highest weight is the mode that the network determines is the most likely for the given agent.

The network is trained based on a set of training data that includes training inputs having agent histories and training ‘ground truth’ trajectories against which the network predictions can be compared and the network weights updated so as to minimise a suitable loss function that penalises predicted trajectories that deviate from the ground truth trajectories. This is described in more detail below.

Preferred embodiments will now be described by way of example only.

The network described above produces multi-modal predictions with a spatial distribution represented as a Gaussian Mixture Model (GMM). This is designed to address scenes with varying numbers of neighbouring agents, which occur in a diverse range of positions in scenarios with widely varying shapes. Neighbouring agents are treated as symmetric entities in an unordered set, which removes the need to assign specific roles based on relative positions, allowing flexible comparisons to be performed.

Observed historic states of each agent are processed using temporal convolutions. Pair-wise comparisons are performed by broadcasting features of each agent with each other agent, where each agent pair is represented in a symmetric unordered set. This allows the effects of interactions between all neighbouring agents to allow to be modelled using pair-wise relationships. Reduced representations of agents and agent pairs are combined to produce a representation of the scene context, which is used to influence predictions of agent trajectories, predicted spatial distributions and probabilistic estimates.

The inputs to the model are the observed history of each agent represented as positions, orientations (represented as a unit vector) and speeds. The model predicts trajectories as future positions, orientations and speeds over a number of modes, as well as a spatial distribution for each timestep represented as standard deviations of two principle axes and a rotation vector, for each timestep and mode. Predicted weights of each mode are also produced as output.

### Training

Training is performed based on a spatial distribution loss, a regression loss and a mode weight estimation loss.

Training mode weights are used to influence the extent that each predicted mode will be trained to be closer to the ground-truth, where a flat training distribution produces convergent modes while a biased distribution will encourage diversity.

Training mode weights Wᵣ are a combination of the closest mode weight W_{c} and posterior mode weight Wₚ, as shown below with reference to Equation [5]. W_{c} is a strongly biased (one-hot) distribution that encourages training of the single most similar mode to the ground truth.

$${d}_{m} = \frac{1}{T} {\sum }_{i}^{T} ‖ {x}_{i} - {μ}_{m , t} ‖ \qquad ( 1 )$$

$${W}_{c , m} = \{ \begin{matrix}1 & if {d}_{m} = {min}_{m} ( {d}_{m} ) \\ 0 & otherwise\end{matrix} \qquad ( 2 )$$

Wₚ is a weakly-biased distribution based on the posterior of the observation under the Gaussian Mixture Model, and produces a balance of convergent and divergent training that facilitates participation of the different modes.

$${p}_{m , t} = \frac{𝒩 ( x , {μ}_{m , t} , {\sum }_{m , t} )}{{\sum }_{i}^{M} 𝒩 ( x , {μ}_{i , t} , {\sum }_{i , t} )} \qquad ( 3 )$$

$${W}_{p , m} = \frac{1}{T} {\sum }_{i}^{T} {p}_{m , t} \qquad ( 4 )$$

The combined training weight distribution Wᵣ is as follows.

$${W}_{r} = \frac{1}{2} ( {W}_{c} + {W}_{p} ) \qquad ( 5 )$$

In contrast, MFP uses a combination of posterior and predicted distribution weights for training the parameters of the GMM, which has a tendency to produce a single dominant mode.

The spatial distribution loss used for training the parameters of the spatial GMM distribution is based on minimising the MLL score of an observation x under the predicted model, weighted by the training mode distribution Wᵣ. The loss is averaged over timesteps as shown in Equation [7]. The spatial loss is used to update the trainable parameters of the normal distribution N [symbol] (x, μ_{m,t}, Σ_{m,t}) for each mode and timestep, while the training weights Wᵣ are constant.

$${LL}_{t} = ln ( {\sum }_{m}^{M} {W}_{r , m} 𝒩 ( x , {μ}_{m , t} , {\sum }_{m , t} ) ) \qquad ( 6 )$$

$${loss}_{spatial} = - \frac{1}{T} {\sum }_{t}^{T} {LL}_{t} \qquad ( 7 )$$

Regression training is performed using the mean-squared-error (MSE) between predicted mode centre positions and observed positions, weighted using the training weight distribution, as shown in Equation 16. This performs training of the predicted positions while the training weight Wᵣ is constant. MSE loss is independent of the spatial distribution parameters, allowing training that is sensitive to Euclidian distance (rather than Mahalanobis distance), and corresponds with displacement-based evaluations (ADE/FDE/RMS).

$${MSE}_{m} = \frac{1}{T} {\sum }_{i}^{T} {‖ {x}_{t} - {μ}_{m , t} ‖}^{2} \qquad ( 8 )$$

$${loss}_{regression} = {\sum }_{m}^{M} {W}_{r , m} {MSE}_{m} \qquad ( 9 )$$

Mode estimation is performed with a MSE-based method that minimises the weighted MSE score, a NLL-based method that minimises the NLL score, and a training-weight method to be similar to the training mode distribution. The MSE-based mode prediction trains predicted soft mode weights Wₛ to minimise the weighted MSE score as shown in Equation [10], which minimises the weighting instances with large displacement errors. Predicted mode weights Wₛ are trained while the MSE term is constant.

$${loss}_{mode \_ MSE} = {\sum }_{m}^{M} {W}_{s} {MSE}_{m} \qquad ( 10 )$$

The NLL-based mode prediction trains the predicted NLL weights Wₙ based on optimisation of the NLL function loss_{mode_NLL} as shown in Equation [11], where training is performed on the predicted mode weights Wₙ and the parameters of the normal distribution are kept constant.

$${LL}_{n , t} = ln ( {\sum }_{m}^{M} {W}_{n , m} 𝒩 ( x , {μ}_{m , t} , {\sum }_{m , t} ) ) \qquad ( 11 )$$

$${loss}_{mode \_ NLL} = - \frac{1}{T} {\sum }_{t}^{T} {LL}_{n , t} \qquad ( 12 )$$

An additional training loss minimises the difference between the predicted mode weight Wₙ and the training mode distribution Wᵣ, using the Kullback-Leibler divergence, as shown in Equation [13], where Wₙ is trained and Wᵣ is constant. Training of predicted mode weights is performed based on the sum of the various mode losses.

$${loss}_{mode \_ train} = {D}_{KL} ( {W}_{r} ‖ {W}_{n} ) \qquad ( 13 )$$

Two mode estimation distributions are predicted, Wₛ and Wₙ, which favour RMS-based and NLL evaluation respectively. As the task is defined based on a single mode estimation weight, an average is returned

$${W}_{output} = \frac{1}{2} ( {W}_{s} + {W}_{n} ) .$$

### Evaluation

A number of variations exist between different implementations of common evaluation measures, and there are practical problems with existing NLL evaluation measures, so details of the measures used are described as follows.

### Negative-Log-Likelihood Evaluation

147 NLL is an evaluation measure that describes the log-probability of observed instances under a probabilistic model. Previous methods [12, 13, 11] have used a Gaussian Mixture Model (GMM) representation to describe the probability distribution, although NLL is a general property that can be compared between different representations.

One limitation in previous uses is that probability density functions with different units have been used, for example in feet [12] or meters [11]. A summary over a set of instances uses an average of the non-linear log function, so a value in units of [ln ft−2] cannot be compared with values in [lnm−2] without access to the value of each instance. To address this problem units of measurement are presented, and evaluations of MFP [12] are re-calculated using meter units.

Another limitation is that in existing definitions NLL is an unbounded quantity which allows scores on a small number of instances to greatly influence an evaluation on the dataset. This is both a theoretical and a practical problem, as for example a dataset may contain a stationary object, and using a GMM a center point can be predicted matching the observed position, and the width of the distribution reduced to produce an arbitrarily high probability density, which is bounded only by numerical limits. For example probability density values represented by a 64-bit float (with limit 5.5×10−309) can result in a NLL score of −710 for a single instance.

A maximum probability density is suggested herein, as for vehicle prediction there is no practical advantage in distinguishing between very tight bounds. Mercat et al. [11] apply a limit of σ=0.1 m to avoid overfitting although this definition is incomplete due to unrestricted correlation values. The definition to be applied on the evaluation is extended where the probability density or the NLL score is limited for each instance, using a maximum probability density of

$$\frac{1}{2 π0 {\text{.2}}^{2}} m - 2 ( approx . 15.92 m - 2 ) ,$$

and minimum NLL score of

$$- ln ( \frac{1}{2 π0 {\text{.2}}^{2}} ) ( approx . - 2.77 ln m - 2 ) .$$

This can be used with any probability distribution, including GMMs and raster-based representations.

The NLL score is calculated using a GMM as shown below. This is represented using a center position (μm), 2×2 covariance matrix (Σₘ) and mode weight (wₘ) for each predicted mode, where x is the ground-truth position. This is determined for each predicted future timestep for each instance.

$$𝒩 ( x , {μ}_{m} , {\sum }_{m} ) = \frac{1}{2 π \sqrt{\vert {\sum }_{m} \vert}} e \hat{} ( - \frac{1}{2} ( x - {μ}_{m} ) \hat{} T {\sum }_{- 1}^{m} ( x - {μ}_{m} )$$

$$\vert {NLL}_{raw} = - ln ( {\sum }_{m}^{M} {w}_{m} 𝒩 ( x , {μ}_{m} , {\sum }_{m} ) )$$

$$NLL = max ( {NLL}_{raw} , - ln ( \frac{1}{2 π0 {\text{.1}}^{2}} ) )$$

Evaluation of the root-mean-square (RMS) error of the most probable predicted mode (predRMS), is calculated over a set of instances for a given timestep as shown in below equation, where μ is the predicted position for the most probable mode i, as used in [16, 12, 15].

$$i = {arg max}_{m} ( {w}_{m} )$$

$$predRMS = \sqrt{\frac{1}{N} {\sum }_{n}^{N} {‖ x - {μ}_{i} ‖}^{2}}$$

Minimum average displacement error (minADE) evaluates the average Euclidian distance of the closest predicted trajectory mode against the ground truth, while the minimum final displacement error (minFDE) uses the final position as described in [17].

$$min ADE = {min}_{m} ( \frac{1}{T} {\sum }_{t}^{T} ‖ {x}_{t} - {μ}_{t , m} ‖ )$$

$$min FDE = {min}_{m} ( ‖ {x}_{T} - {μ}_{T , m} ‖ )$$

Miss-rate is defined as the percentage of instances where the prediction on the final timestep is larger than a given threshold, over all modes. A threshold of 2 m is used, as used in [4, 11].

Evaluations are performed on motor vehicle agents only, while other agent types in the scene such as pedestrians or cyclists may be observed as neighbours. Evaluations are only performed on agent instances where data is available over the full time window, including the observed and future time period. On the NGSIM dataset a historical sequence of 30 frames are observed sampled at 10 Hz, and 50 frames are predicted. 10 frames are observed and 30 frames predicted on Interaction, also at 10 Hz. Each evaluation is reported for a single experiment run for each method, and is important for showing the trade-offs between different objectives.

### Experiments and Results

Experiments are conducted on the Interaction and NGSIM datasets, to compare closest-mode and probabilistic prediction of the method herein against a baseline prior method using a revised implementation of MFP [12]. Further experiments are conducted on Interaction to compare closest-mode prediction of the DiPA method herein against prior methods, and on the NGSIM dataset to compare probabilistic scoring against prior method benchmarks. MFP [12] is a useful baseline for comparison as it is an accurate method based a multi-modal representation with a spatial distribution. This allows comparison on each of the proposed evaluation measures, including minADE/FDE/MR, predRMS and NLL. A limitation of this method is that it has been implemented based on local lane-based coordinates which are suitable for highway driving involving a number of mostly parallel lanes. This representation is not directly generalisable to more complex scenarios involving intersections, roundabouts and other non-parallel topology.

A revised implementation using global coordinates is implemented, in order to allow generalisation to other datasets such as Interaction. For consistency with the local coordinates in NGSIM, each instance is re-framed based on the last observed position and orientation of the central agent. The position history of each agent is rotated and shifted to produce a normalised representation.

A revised neighbour grid representation is used to run on the more general Lanelet2 [19] maps in Interaction. MFP represents neighbours using a 13×3 grid of positions in the central and neighbouring lanes, based on distances from the central agent. NGSIM is based largely on parallel lanes, allowing the neighbour grid to be defined based on progress distances along each lane, however much more complex lane structures exist in Interaction scenarios. A comparable neighbour grid is produced for an instance by identifying the lane patches corresponding with the central agent, and identifying all lane patches following or preceding from the central lane patch(es), which represent the central lane.

Left neighbours are found by identifying patches with a left-neighbour relationship from the central patch(es), and finding all following and preceding lane patches, which represent left-lanes in the grid (and similar for right lanes). Grid spacing distances for each neighbour are found based on the nearest midline path of the lane, and comparing the progress distance of the neighbour agent with the central agent along the given lane midline. This allows the construction of a similar neighbour grid to that used in MFP.

Results of experiments on NGSIM using the common predRMS and NLL evaluations are shown in Table 1. These show that the revised MFP-global method is able to operate with slightly higher error than original implementation. DiPA improves over previous methods for predicting the most probable mode (predRMS), and shows comparable accuracy for prediction of the spatial distribution (NLL). This indicates that DiPA is able to capture an accurate probabilistic model of agent behaviour compared to previous probabilistic methods. Results of experiments on the standard INTERACTION evaluation measures are shown in Table 2.

This shows that DiPA produces a model with higher accuracy of predicting the closest mode than the comparison methods. This shows that the method is able to produce a model with a diverse set of predicted modes that accurately capture behaviours observed in the INTERACTION dataset.

Comparison using both closest-mode and probabilistic evaluations from the same run show that the baseline MFP methods produce accurate probabilistic predictions and show good scores on the predRMS and NLL evaluations on NGSIM (Table 1), however show relatively high error on the minADE/FDEevaluations (Table 3). This shows limited diversity of predictions to closely match individual instances is produced, and that a prediction strategy of reliable prediction is being produced.

TABLE 1
Probabilistic scores on NGSIM, including predRMS with varying modes, and NLL with
5 modes. Values above the single-line divider are previously reported and are not
necessarily from the same run, values below the line are newly calculated and each
row is from the same run, with NLL including thresholding, as described in Section 3.1.
Values below the double line show comparison of different values for Wₒ.

| | predRMS (by time period) [m] | | | | | NLL (by time period) [ln m⁻²] | | | | |
|---|---|---|---|---|---|---|---|---|---|---|
| Method | 1 s | 2 s | 3 s | 4 s | 5 s | 1 s | 2 s | 3 s | 4 s | 5 s |
| CV [19] | 0.76 | 1.82 | 3.17 | 4.80 | 6.70 | 0.82 | 2.32 | 3.23 | 3.91 | 4.46 |
| CSP(M) [16, 12] | 0.59 | 1.27 | 2.13 | 3.22 | 4.64 | −0.41 | 1.07 | 1.93 | 2.55 | 3.08 |
| GRIP [20]† | 0.52 | 1.22 | 2.05 | 3.13 | 4.47 | | | | | |
| SAMMP [12] | 0.51 | 1.13 | 1.88 | 2.81 | 3.98 | −0.36 | 0.70 | 1.51 | 2.13 | 2.64 |
| MFP [13] | 0.54 | 1.16 | 1.90 | 2.78 | 3.83 | | | | | |
| Flash [6] | 0.52 | 1.15 | 1.84 | 2.64 | 3.63 | | | | | |
| MFP-original | 0.54 | 1.17 | 1.87 | 2.71 | 3.67 | −0.64 | 0.71 | 1.56 | 2.21 | 2.74 |
| MFP-global | 0.64 | 1.31 | 2.16 | 3.21 | 4.46 | −0.55 | 0.96 | 1.84 | 2.50 | 3.03 |
| DiPA | 0.46 | 1.04 | 1.70 | 2.44 | 3.39 | −1.04 | 0.41 | 1.45 | 2.24 | 2.82 |
| DiPA (Wₒ = Wₛ) | | | | | | | | | | |
| DiPA (Wₒ = Wₙ) | 0.47 | 1.08 | 1.79 | 2.62 | 3.64 | −1.24 | 0.18 | 1.21 | 2.00 | 2.60 |

†adjusted to correct for scoring based on RMS with average over spatial dimension values instead of RMS of Euclidean distances.

TABLE 2
Closest-mode scores on INTERACTION, 6 modes.

| Method | minADE | minFDE | MR |
|---|---|---|---|
| TNT [4] | 0.21 | 0.67 | |
| ReCoG [7] | 0.19 | 0.66 | |
| ITRA [11] | †0.17 | 0.49 | |
| GoHome [9] | | 0.45 | |
| StarNet [10] | *†0.16 | *0.49 | |
| joint-StarNet [10] | *†0.13 | *0.38 | |
| MFP-Lanelet2 | 0.47 | 1.29 | 0.22 |
| DiPA | 0.11 | 0.34 | 0.02 |

*the method is run with a 2.5 second observed window instead of 1 second, which may change the dataset. distribution.
†the method uses RMS rather than linear average.

DiPA is able to produce good scores on both types of evaluation, 279 indicating it is able to capture both diverse and accurate predictions on NGSIM. Miss-rate scores are substantially improved using DiPA compared to previous methods, including against previously reported NGSIM methods. This shows that DiPA captures individual instances much more closely than previous NGSIM methods.

The prediction task has been defined using a single predicted mode weight Wₒ=½(Wₛ+Wₙ), however mode weights that favour the predRMS task can be inconsistent from those favouring NLL evaluation. A comparison of the effect of evaluating using either Wₛ or Wₙ alone with the same trained model is shown in Table 1 (bottom), showing that Wₛ mode weights favour RMS scores at a cost of NLL evaluations while Wₙ produces lower NLL error with some increase to RMS errors, and the method herein provides a balance.

TABLE 3
Closest-mode scores on NGSIM, 5 modes. Each is
measured from the same instance as in Table 1.

| Method | minADE | minFDE | MR |
|---|---|---|---|
| CV [19] | | | 0.71 |
| CSP(M) [16, 12] | | | 0.44 |
| SAMMP [12] | | | 0.23 |
| MFP-original | 1.07 | 2.15 | 0.40 |
| MFP-global | 1.17 | 2.44 | 0.43 |
| DiPA | 0.47 | 0.85 | 0.07 |

On INTERACTION the DiPA method herein produces improved results on all evaluation measures compared to the MFP-Lanelet2 baseline (Tables 4,2). The MFP-Lanelet2 implementation has shown the ability to generalise MFP to operate on the wide range of scenarios present in the INTERACTION dataset. DiPA has been designed to use a more general input representation than the grid-representation used by MFP, allowing more flexible use on different scenarios. Overall DiPA has shown good results for producing diverse predictions that capture instances in the dataset (shown on minADE/FDE/MR scores), while also showing high probabilistic prediction accuracy.

TABLE 4
Probabilistic scores |on INTERACTION, 6 modes.
Each is measured from the same instance as in Table 2.

| | predRMS [m] | | | NLL [ln m⁻²] | | |
|---|---|---|---|---|---|---|
| Method | 1 s | 2 s | 3 s | 1 s | 2 s | 3 s |
| MFP-Lanelet2 | 0.22 | 0.97 | 2.44 | −1.74 | 0.51 | 2.18 |
| DiPA | 0.22 | 0.58 | 1.39 | −2.05 | −0.70 | 0.92 |

DiPA does not use any map information. The dataset involves training and evaluation on common road layouts, which allows the model to learn properties of the map implicitly from observations, and produce accurate predictions on the dataset that may not be generalisable. As an example an agent travelling straight for a certain distance may have a tendency to turn right afterwards in the dataset, and this behaviour can be learnt by the model.

The model can occasionally produce predictions with large displacements, that are substantially different to normal vehicle behaviour. This can be caught using a wrapper around the network model that checks if predicted velocities are unrealistic, currently with a threshold of 40 m/s, tested on each timestep. Outlier values are rescaled to the threshold limit.

In order to produce a practical predictor for supporting an Autonomous Vehicle for operating in interactive scenarios, it is important to produce diverse predictions that capture a number of different modes of behaviour that other agents may follow, and also to predict the probability that each may occur. This allows modelling of expected behaviours and produces an estimate of the probability that spatial regions may be occupied, which can be used by a planner to assess risk of different possible plans for the ego vehicle. A limitation of previous predictors is that they have demonstrated producing a diverse prediction strategy without capturing probabilities of the various modes (on INTERACTION), or have demonstrated producing reliable probabilistic estimates based on a conservative set of predicted modes (on NGSIM).

The DiPA method has demonstrated the ability to capture diverse predictions with lower minADE/FDE error than previous methods, while also producing probabilistic estimates on interactive scenarios better than the baseline method. This demonstrates the ability to capture a diverse-accurate prediction strategy, which is useful for supporting an autonomous vehicle.

DiPA uses a flexible representation of observed agents that does not require specific roles to be assigned, and is based on versatile pair-wise comparisons to capture interactions between different agents in the scene, allowing generalisability for operating on different scenarios with widely varying road layouts.

It will be appreciated that the term “stack” encompasses software, but can also encompass hardware. A stack may be deployed on a real-world vehicle, where it processes sensor data from the on-board sensors, and controls the vehicle's motion via the actor system 112.

References herein to agents, vehicles, robots and the like include real-world entities but also simulated entities. The techniques described herein have application on a real-world vehicle, but also in simulation-based autonomous vehicle testing. For example, the inverse planning prediction method may be performed within the prediction system 104 when the stack 100 is tested in simulation. As another example, the stack 100 may be used to plan ego trajectories/plans to be used as a benchmark for other AV stacks. In simulation, software of the stack may be tested on a “generic” off-board computer system, before it is eventually uploaded to an on-board computer system of a physical vehicle. However, in “hardware-in-the-loop” testing, the testing may extend to underlying hardware of the vehicle itself. For example, the stack software may be run on the on-board computer system (or a replica thereof) that is coupled to the simulator for the purpose of testing. In this context, the stack under testing extends to the underlying computer hardware of the vehicle. As another example, certain functions of the stack 110 (e.g. perception functions) may be implemented in dedicated hardware. In a simulation context, hardware-in-the loop testing could involve feeding synthetic sensor data to dedicated hardware perception components.

References herein to components, functions, modules and the like, denote functional components of a computer system which may be implemented at the hardware level in various ways. A computer system comprises execution hardware which may be configured to execute the method/algorithmic steps disclosed herein and/or to implement a model trained using the present techniques. The term execution hardware encompasses any form/combination of hardware configured to execute the relevant method/algorithmic steps. The execution hardware may take the form of one or more processors, which may be programmable or non-programmable, or a combination of programmable and non-programmable hardware may be used. Examples of suitable programmable processors include general purpose processors based on an instruction set architecture, such as CPUs, GPUs/accelerator processors etc. Such general-purpose processors typically execute computer readable instructions held in memory coupled to or internal to the processor and carry out the relevant steps in accordance with those instructions. Other forms of programmable processors include field programmable gate arrays (FPGAs) having a circuit configuration programmable through circuit description code. Examples of non-programmable processors include application specific integrated circuits (ASICs). Code, instructions etc. may be stored as appropriate on transitory or non-transitory media (examples of the latter including solid state, magnetic and optical storage device(s) and the like). The subsystems 102-108 of the runtime stack of Figure A may be implemented in programmable or dedicated processor(s), or a combination of both, on-board a vehicle or in an off-board computer system in the context of testing and the like.

The following references are incorporated herein by reference in their entirety:
[1] W. Zhan, L. Sun, D. Wang, H. Shi, A. Clausse, M. Naumann, J. Kummerle, H. Konigshof, C. Stiller, A. de La Fortelle, et al. Interaction dataset: An international, adversarial and co-operative motion dataset in interactive driving scenarios with semantic maps. arXiv preprint arXiv:1910.03088, 2019.
[2] J. Colyar and J. Halkias. NGSIM—US highway 101 dataset, 2006. URL https://www.fhwa.dot.gov/publications/research/operations/07030/07030.pdf. Accessed May 2021.
[3] J. Colyar and J. Halkias. NGSIM-interstate 80 freeway dataset, 2006. URL https://www.fhwa.dot.gov/publications/research/operations/06137/06137.pdf. Accessed May 2021.
[4] H. Zhao, J. Gao, T. Lan, C. Sun, B. Sapp, B. Varadarajan, Y. Shen, Y. Shen, Y. Chai, C. Schmid, et al. TNT: Target-driven trajectory prediction. arXiv preprint arXiv:2008.08294, 2020.
[5] J. Gu, C. Sun, and H. Zhao. DenseTNT: End-to-end trajectory prediction from dense goal sets. In Proceedings of the IEEE/CVF International Conference on Computer Vision, pages 15303-15312, 2021.
[6] X. Mo, Y. Xing, and C. Lv. ReCog: A deep learning framework with heterogeneous graph for interaction-aware trajectory prediction. arXiv preprint arXiv:2012.05032, 2020.
[7] X. Jia, L. Sun, H. Zhao, M. Tomizuka, and W. Zhan. Multi-agent trajectory prediction by combining egocentric and allocentric views. In Conference on Robot Learning, pages 1434-1443. PMLR, 2022.
[8] T. Gilles, S. Sabatini, D. Tsishkou, B. Stanciulescu, and F. Moutarde. GoHome: Graph-oriented heatmap output for future motion estimation. arXiv preprint arXiv:2109.01827, 2021.
[9] A. Ścibior, V. Lioutas, D. Reda, P. Bateni, and F. Wood. Imagining the road ahead: Multi-agent trajectory prediction via differentiable simulation. In 2021 IEEE International Intelligent Transportation Systems Conference (ITSC), pages 720-725. IEEE, 2021.
[10] F. Janjoš, M. Dolgov, and J. M. Zöllner. StarNet: Joint action-space prediction with star graphs and implicit global frame self-attention. arXiv preprint arXiv:2111.13566, 2021.
[11] J. Mercat, T. Gilles, N. El Zoghby, G. Sandou, D. Beauvois, and G. P. Gil. Multi-head attention for multi-modal joint vehicle motion forecasting. In 2020 IEEE International Conference on Robotics and Automation (ICRA), pages 9638-9644. IEEE, 2020.
[12] C. Tang and R. R. Salakhutdinov. Multiple futures prediction. Advances in Neural Information Processing Systems, 32, 2019.
[13] H. Song, W. Ding, Y. Chen, S. Shen, M. Y. Wang, and Q. Chen. PiP: Planning-informed trajectory prediction for autonomous driving. In European Conference on Computer Vision, pages 598-614. Springer, 2020.
[14] B. Mersch, T. Höllen, K. Zhao, C. Stachniss, and R. Roscher. Maneuver-based trajectory prediction for self-driving cars using spatio-temporal convolutional networks. In 2021 IEEE/RSJ International Conference on Intelligent Robots and Systems (IROS), pages 4888-4895. IEEE, 2021.
[15] M. Antonello, M. Dobre, S. V. Albrecht, J. Redford, and S. Ramamoorthy. Flash: Fast and light motion prediction for autonomous driving with bayesian inverse planning and learned motion profiles. arXiv preprint arXiv:2203.08251, 2022.
[16] N. Deo and M. M. Trivedi. Convolutional social pooling for vehicle trajectory prediction. In Proceedings of the IEEE Conference on Computer Vision and Pattern Recognition Workshops, pages 1468-1476, 2018.
[17] W. Zhan, L. Sun, H. Ma, C. Li, X. Jia, and M. Tomizuka. Interpret challenge, 2021. URL https://github.com/interaction-dataset/INTERPRET_challenge_single-agent. Accessed May 2021.
[18] S. Kullback and R. A. Leibler. On information and sufficiency. The annals of mathematical statistics, 22(1):79-86, 1951.
[19] F. Poggenhans, J.-H. Pauls, J. Janosovits, S. Orf, M. Naumann, F. Kuhnt, and M. Mayr. Lanelet2: A high-definition map framework for the future of automated driving. In Proc. IEEE Intell. Trans. Syst. Conf, Hawaii, USA, November 2018. URL http://www.mrt.kit.edu/z/publ/download/2018/Poggenhans2018Lamelet2.pdf.
[20] J. Mercat, N. E. Zoghby, G. Sandou, D. Beauvois, and G. P. Gil. Kinematic single vehicle trajectory prediction baselines and applications with the ngsim dataset. arXiv preprint arXiv:1908.11472, 2019.
[21] X. Li, X. Ying, and M. C. Chuah. Grip: Graph-based interaction-aware trajectory prediction. In 2019 IEEE Intelligent Transportation Systems Conference (ITSC), pages 3960-3966. IEEE, 2019.

1. A computer-implemented method of predicting trajectories for agents of a scenario, the method comprising, for each agent:
generating an agent feature vector based on one or more observed past states of the agent,
computing a set of pairwise feature vectors, each pairwise feature vector computed as a combination of the agent feature vector for that agent with a respective one of agent feature vectors generated for each other agent of the scenario,
processing the pairwise feature vectors as independent inputs to one or more interaction layers of a trajectory prediction neural network to generate a pairwise output for each pairwise feature vector,
aggregating pairwise outputs over the other agents of the scenario to generate an interaction-based feature representation for each agent,
processing the interaction-based feature representation in one or more prediction layers of the trajectory prediction neural network, and
generating, based on output of the one or more prediction layers, at least one predicted trajectory for each agent.

2. A method according to claim 1, wherein
the agent feature vector is further based on one or more spatial dimensions of the agent; or
the agent feature vector is determined by computing a temporal convolution of a time series of past states of each agent; or
the agent feature vector is based on one or more spatial dimensions of the agent and is determined by computing a temporal convolution of a time series of past states of each agent.

3. (canceled)

4. A method according to claim 1, wherein each past state of each agent comprises one or more of a position, an orientation and a velocity of the agent at a given timestep.

5. A method according to claim 1, wherein:
the observed past states of each agent are obtained by applying a perception system to one or more sensor outputs; or
the observed past states are obtained by manual annotation of sensor data.

6. (canceled)

7. A method according to claim 5, wherein the sensor data comprises at least one of: radar data, lidar data and camera images.

8. A method according to claim 1, wherein each pairwise feature vector is computed by concatenating the agent feature vector of each agent with a different respective one of the agent feature vectors of the other agents of the scenario.

9. A method according to claim 1, wherein:
the interaction-based feature representation is combined with the agent feature vector before being input to the prediction layers; or
the interaction-based feature representation comprises an interaction feature vector, and wherein the interaction-based feature representation is combined with the agent feature vector, before being input to the prediction layers, by concatenating the interaction feature vector with the agent feature vector.

10. (canceled)

11. A method according to claim 1, wherein the one or more prediction layers of the trajectory prediction neural network comprises a first set of prediction layers and a second set of prediction layers,
wherein the output of the first set of prediction layers for each agent is combined with a common scene context representation to generate a combined representation, and
wherein the combined representation for each agent is processed by the second set of prediction layers to generate a predicted trajectory for each agent.

12. A method according to claim 11, wherein the scene context representation is computed by aggregating the outputs of the first set of prediction layers over the agents of the scenario.

13. A method according to claim 1, wherein the pairwise outputs are aggregated by performing a max reduction operation over the agents of the scene, by computing, for the scene as a whole, a maximum feature value of each feature over all intermediate outputs.

14. A method according to claim 1, wherein
the trajectory prediction neural network is configured to generate a fixed number of predicted trajectories, each predicted trajectory corresponding to a different prediction mode; or
the trajectory prediction neural network is configured to generate a fixed number of predicted trajectories, each predicted trajectory corresponding to a different prediction mode and the trajectory prediction neural network is further configured to output a weight for each prediction mode, wherein the weight indicates a confidence in the respective prediction mode.

15. (canceled)

16. A method according to claim 14, wherein the trajectory prediction neural network is configured to generate a spatial distribution over the fixed number of predicted trajectories, a distribution encoding uncertainty in the predicted trajectory of each agent.

17. A method according to claim 1, wherein the prediction neural network is trained by predicting trajectories for scenarios of a training set for which observed trajectories are known, and optimising a loss function that penalises deviations between predicted trajectories and observed trajectories of the training set.

18. A method according to claim 1, wherein one of the agents of the scenario is an autonomous vehicle agent.

19. A method according to claim 18, comprising:
outputting the predicted trajectories to an autonomous vehicle planner, and generating, by the autonomous vehicle planner, a planned trajectory for the autonomous vehicle agent in presence of other agents of the scenario; or
outputting the predicted trajectories to an autonomous vehicle planner, and generating, by the autonomous vehicle planner, a planned trajectory for the autonomous vehicle agent in the presence of other agents of the scenario, and generating, by a controller, control signals to implement the planned trajectory for the autonomous vehicle agent.

20. (canceled)

21. A non-transitory medium embodying computer-readable instructions configured, when executed on one or more hardware processors to train a trajectory prediction neural network at least by:
receiving a plurality of training instances, each training instance comprising a set of past states for a plurality of agents of a scenario and a corresponding ground truth trajectory for each agent;
for each agent of a training instance:
generating an agent feature vector for each agent based on one or more observed past states of the agent,
computing a set of pairwise feature vectors, each pairwise feature vector computed as a combination of the agent feature vector for that agent with a respective one of the agent feature vectors generated for each other agent of the scenario,
processing the pairwise feature vectors as independent inputs to one or more interaction layers of a trajectory prediction neural network to generate a pairwise output for each pairwise feature vector,
aggregating the pairwise outputs over the other agents of the scenario to generate an interaction-based feature representation for each agent,
processing the interaction-based feature representation in one or more prediction layers of the trajectory prediction neural network, and
generating, based on the output of the one or more prediction layers, at least one predicted trajectory for each agent;
updating one or more parameters of the trajectory prediction neural network so as to optimise a loss function based on the at least one predicted trajectory for each agent and the corresponding ground truth trajectory for that agent.

22. The non-transitory medium of claim 21, wherein the loss function comprises one or more of a spatial distribution loss function, a regression loss function, and a mode weight estimation loss function.

23. (canceled)

24. A computer system comprising:
at least one memory configured to store computer-readable instructions;
at least one hardware processor coupled to the at least one memory and configured to execute the computer-readable instructions, which upon execution cause the at least one hardware processor to predict trajectories for agents of a scenario by, for each agent:
generating an agent feature vector based on one or more observed past states of the agent,
computing a set of pairwise feature vectors, each pairwise feature vector computed as a combination of the agent feature vector for that agent with a respective one of the agent feature vectors generated for each other agent of the scenario,
processing the pairwise feature vectors as independent inputs to one or more interaction layers of a trajectory prediction neural network to generate a pairwise output for each pairwise feature vector,
aggregating the pairwise outputs over the other agents of the scenario to generate an interaction-based feature representation for each agent,
processing the interaction-based feature representation in one or more prediction layers of the trajectory prediction neural network, and
generating, based on the output of the one or more prediction layers, at least one predicted trajectory for each agent.

25. A method according to claim 1, wherein a perception system receives sensor outputs from an onboard sensor system of the agent and uses the sensor outputs to detect external agents and measure their physical state.

26. A method according to claim 1, wherein generating at least one predicted trajectory for each agent comprises generating a respective predicted trajectory for each of a fixed number of prediction modes with a corresponding weight which indicates each predicted mode, wherein the predicted mode with a highest weight is the mode that the network determines is most likely for the agent.
